(19) United States
(12) Patent Application Publication
(10) Pub. No.: US 2018/0176726 A1
(43) Pub. Date: Jun. 21, 2018

(54) SYSTEM FOR MONITORING THE ACTIVITY STATUS OF AT LEAST ONE VENUE

(71) Applicant: SPOTBEAT, INC., Boston, MA (US)

(72) Inventor: Alexander E. Beal, Marlborough, MA (US)

(21) Appl. No.: 15/610,693

(22) Filed: Jun. 1, 2017

Related U.S. Application Data
(60) Provisional application No. 62/435,147, filed on Dec. 16, 2016.

(51) Int. Cl. H04W 4/02; H04L 29/08; G06Q 50/00; G06Q 30/02

(52) U.S. Cl. CPC H04W 4/021; H04L 67/22; G06Q 30/0201; G06Q 50/01; H04L 67/20

(57) ABSTRACT

A venue monitoring system includes an activity tracker that fetches geolocation data from active mobile devices in order to estimate real-time crowd sizes at certain venues, such as restaurants, bars, nightclubs and the like. By comparing detected crowd sizes against a fixed numerical parameter, such as a predefined occupancy load, the activity tracker is able to designate a real-time activity status for each monitored venue that is indicative of its social atmosphere. End users in electrical communication with the activity tracker are able to intuitively discern the relative popularity of a plurality of venues within a common geographic region using a designated software application. As a critical component of the application functionality, a graphical display is provided to the end user that represents the activity status of monitored venues by integrating dynamic indicators, which vary in size, color and pulse rate, into a web mapping service.

### FIELD OF THE INVENTION

The present invention relates generally to information technology and, more particularly, to systems and methods for providing electronic data relating to notable aspects of commercial businesses.

### BACKGROUND OF THE INVENTION

Information technology (IT) relates to the use of computers to compile, transmit, and receive information on a seemingly limitless range of subjects. With the advancement of information technology as well as the ubiquitous use of mobile devices, the consuming public has become increasingly reliant upon electronic data when evaluating commercial businesses.

In particular, there is currently available a growing amount of relevant information on commercial establishments that provide food, drink and entertainment services, such as restaurants, bars, nightclubs and the like. By evaluating such information, a member of the consuming public can more effectively decide whether to visit certain establishments.

Basic information relating to an establishment is often provided on a designated webpage, such as a company website, that can be readily identified by the consuming public, for instance, using an appropriate search engine. Examples of the types of basic information that is typically available include, inter alia, the business name, address, telephone number, hours of operation, photos, and pricing.

Additional information on an establishment is often crowdsourced through designated software applications. For instance, certain applications compile a collection of data from the consuming public, such as personal experiences, reviews and photographs, to provide a broader and more objective impression of the business.

Nonetheless, the majority of information that is currently available on an establishment, whether provided directly from the establishment or crowdsourced through patrons, is static. In other words, much of the available information on a business remains largely unchanged over time and thereby fails to reflect the dynamic nature of such establishments. As a result, the consuming public frequently decides whether to visit an establishment using an insufficient amount of information, much of which is often stale or inexact.

Most notably, there is currently no effective means to compile and evaluate, in real time, crowd-based information relating to selected establishments within a particular geographic region. In the absence of such information, a potential patron is unable discern the real-time popularity and social atmosphere of an establishment, which is often a critical factor when rendering a decision where to visit.

For instance, certain patrons may seek an establishment that is highly active and bustling (i.e., hosting a relatively large crowd) and, as such, would be willing to pay a designated fee (e.g., a cover charge) and/or wait for service in order to attend. By contrast, certain patrons may seek an establishment that is less active, providing a relatively quiet environment that would not require a wait for service.

Certain social networking software applications include a check-in feature that accesses geographical coordinates from an active mobile device to notify others within a common network that the user is present within a particular location. However, it has been found that use of such a check-in feature provides limited value in assessing the overall popularity status of certain establishments. Specifically, a rather small percentage of a typical crowd generally elects to engage in an electronic check-in process. Additionally, the check-in information is most commonly restricted to the members of an exclusive network. Lastly, larger establishments routinely accumulate a higher number of check-ins that is based more on the ability to accommodate a greater quantity of patrons than any relative popularity.

### SUMMARY OF THE INVENTION

It is an object of the invention to provide a new and improved system for monitoring the activity status of at least one venue.

It is another object of the present invention to provide a venue monitoring system as described above that displays the activity status of multiple venues in real time.

It is yet another object of the present invention to provide a venue monitoring system as described above that displays the activity status of multiple venues to the end user through a highly intuitive graphical user interface.

It is still another object of the present invention to provide a venue monitoring system as described above that is easily configurable and readily scalable.

Accordingly, as a feature of the present invention, there is provided a system for monitoring one or more venues, the system comprising (a) an activity tracker, the activity tracker comprising a central controller that maintains a count of active mobile devices located within each of the one or more venues, and (b) an end user, the end user comprising a compute device in electrical communication with the central controller, (c) wherein the compute device is adapted to retrieve information from the central controller that is reflective of the count of active mobile devices located within a selection of the one or more venues.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified schematic representation of a system for monitoring the activity status of at least one venue, the system being constructed according to the teachings of the present invention;

FIG. 2 is a flow chart depicting a method of monitoring the activity status of at least one venue using the system shown in FIG. 1;

FIG. 3 is a sample screen display which is useful in illustrating the back-end venue configuration step set forth in FIG. 2;

FIG. 4 is a sample screen display which is useful in illustrating the back-end venue monitoring step set forth in FIG. 2;

FIG. 5 is a sample chart which is useful in illustrating the back-end processing step set forth in FIG. 2, the processing step comparing monitored activity within a venue against the known occupancy rate for the venue in order to calculate a commensurate activity status level; and

FIG. 6 is a sample screen display which is useful in illustrating the front-end user graphical display generation step set forth in FIG. 2, the screen display reflecting the real-time activity status of venues by integrating highly intuitive indicators on an electronic map.

### DETAILED DESCRIPTION OF THE INVENTION

### Venue Monitoring System 11

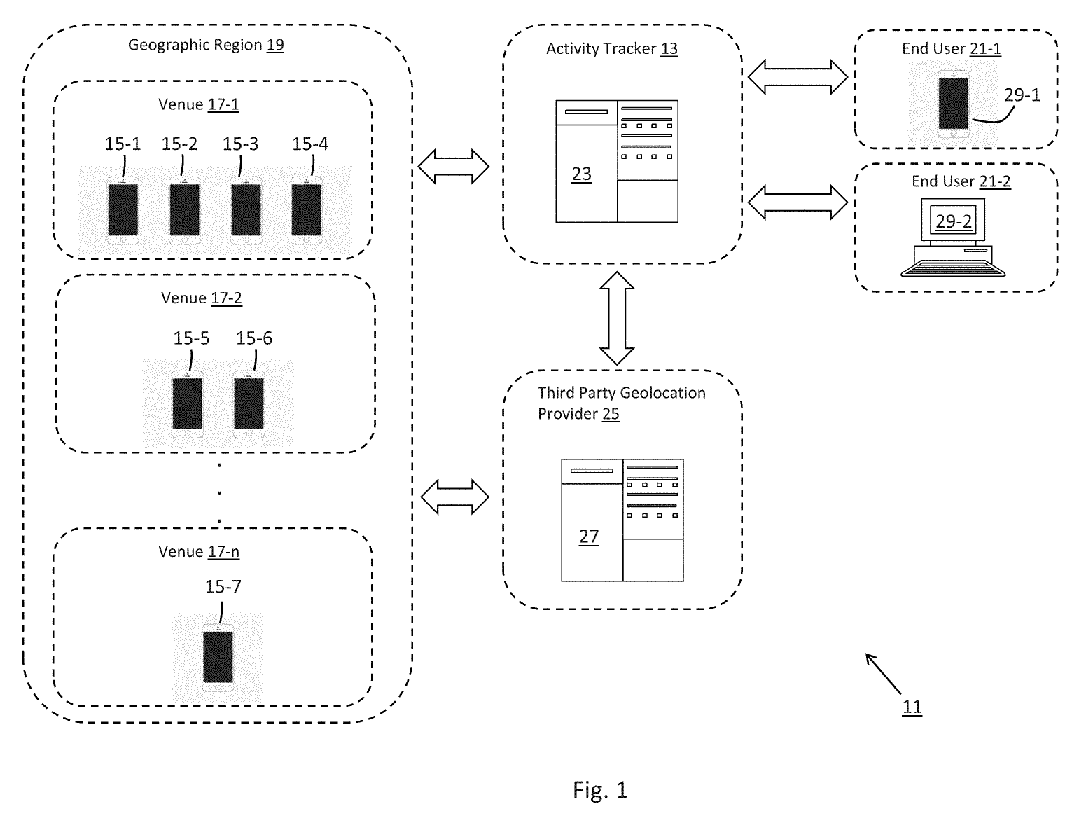

Referring now to FIG. 1, there is shown a simplified schematic representation of a system for monitoring the activity status of at least one venue, the system being constructed according to the teachings of the present invention and identified generally by reference numeral 11. As will be described in detail below, venue monitoring system 11 is designed to track the presence of active mobile devices within selected venues in order to establish a real-time activity status for each venue that is based, in part, on detected crowd size.

As can be seen, venue monitoring system 11 comprises an activity tracker 13 that monitors the use of mobile devices 15 in selected venues 17-1 thru 17-n within a broader geographic region 19. Using such information, activity tracker 13 designates a real-time activity status, or popularity level, for each venue 17 that, in turn, can be retrieved and evaluated by interested parties (e.g., potential patrons amongst the consuming public).

As defined herein, each venue 17 denotes any fixed, geographically-demarcated area. For instance, in the description that follows, each venue 17 is represented as the physical building for a commercial establishment that provides food, drink and/or entertainment services, such as restaurants, bars, nightclubs and the like.

However, it should be noted that each venue 17 need not be limited to a physical building and/or commercial establishment of the type as suggested. Rather, in lieu of a physical building, each venue 17 may represent a broader geographic region that is commonly visited by crowds of people including, but not limited to, a park or portion thereof, a national landmark or other similar type of tourist attraction, or an open public space used for community gatherings, such as a town square or common.

Activity tracker 13 monitors the activity status of venues 17 for end users 21 and, as such, serves as the functional hub of system 11. As will be explained further below, activity tracker 13 assigns an activity status for each venue 17 by comparing the detected crowd size against a defined numerical parameter, such as the maximum occupant load that is stipulated by code for the establishment.

In this manner, the activity status can be used to assess the relative popularity and trending social atmosphere among multiple establishments within a common geographic region. As can be appreciated, there is a previously unrecognized, and hence heretofore unmet, need among the consuming public to be able to compare the activity status of multiple establishments in real time. Using such information, end user 21 (e.g. a potential patron) can select a venue 17 that is appropriately suited to meet his/her needs (e.g., a venue that is heavily crowded and therefore lively versus a more moderately crowded venue with no wait to enter, etc.).

Activity tracker 13 is represented herein as comprising a central controller 23 that (i) monitors activity within selected venues 17 by gathering and tracking geolocation data from active mobile devices 15 (e.g., within broader geographic region 19), (ii) processes such data to designate a commensurate activity status for each monitored venue 17, and (iii) provides the calculated activity status level for each venue 17 to end user 21 using highly intuitive, user-friendly graphical displays, the details of which will be explained further in detail below.

As defined herein, central controller 23 represents any combination of compute devices, such as application servers, web servers and the like, that is programmed to handle, inter alia, the activity status calculations as well as the primary application operations.

Each mobile device 15 is shown herein as a conventional smartphone. However, as defined herein, mobile device 15 represents any portable compute device from which geolocation data can be fetched through normal activity.

In the present example, four mobile devices 15-1 thru 15-4 are shown located within venue 17-1, two mobile devices 15-5 thru 15-6 are shown located within venue 17-2, and a single mobile device 15-7 is shown located within venue 17-n. As can be appreciated, the relative number of mobile devices 15 present within each venue 17 is provided for illustrative purposes in order to demonstrate a simple example of disparity in crowd size, and hence activity, amongst multiple venues within a common geographic region.

As a feature of the present invention, activity tracker 13 gathers and tracks geolocation data from active mobile devices 15 within broader geographic region 19. Using existing technology, the geolocation data can be fetched from each mobile device 15 using, inter alia, global positioning system (GPS) data, known internet protocol (IP) addresses, accessed Wi-Fi, or other positioning systems. In turn, the geolocation data can be used to estimate the real-world geographic location of the mobile device, for example, by geographic coordinates (i.e., based on latitude and longitude).

In the present embodiment, activity tracker 13 is represented as relying upon a combination of sources for fetching geolocation data from mobile devices 15 that are active within geographic region 19.

As a first source, activity tracker 13 preferably digitally fetches geolocation data directly from mobile devices 15 in communication with activity tracker 13 via a designated software application. In other words, mobile devices 15 that are installed with the designated software application used to access the functionality of activity tracker 13 receive a specific request to authorize extraction of geolocation data. In this manner, activity tracker 13 is able to fetch user location data through a geolocation application program interface (API) in the mobile application.

As a second source, activity tracker 13 preferably fetches digital geolocation data indirectly from a third party geolocation provider 25. As can be appreciated, provider 25 represents any website and/or service that utilizes software with a geolocation API which, in turn, is rendered available for use by third party software developers (e.g., upon payment of a requisite fee).

For instance, the Google Maps mapping service offered by Alphabet Inc., of Mountain View, Calif., includes a geolocation API that is available for use by programmers of third party software applications. Accordingly, it is to be understood that application software operating on central controller 23 could fetch user geolocation data using the Google Maps API.

Geolocation provider 25 is represented comprising a controller 27 in electronic communication with selected mobile devices 15 as well as central controller 23. As such, geolocation data compiled by controller 27 through a designated API can, in turn, be electronically retrieved by central controller 23 for activity tracker 13.

As noted above, the activity status information compiled by activity tracker 13 is utilized by end users 21 in electronic communication therewith. As defined herein, end users 21 represent any party interested in utilizing the venue monitoring service afforded by activity tracker 13 (e.g., to decide whether to visit a particular venue 17 based on such information).

System 11 is represented herein as comprising a pair of end users 21-1 and 21-2 that are independently linked with central controller 23 using corresponding compute devices 29-1 and 29-2, respectively. To facilitate communication with central controller 23, each compute device 29 preferably utilizes a designated software application. As will be explained in detail below, the software application provides highly intuitive and user-friendly graphical displays that enable end user 21 to readily discern the real-time activity status of venues 17 within geographic region 19.

Although system 11 is shown with a pair of end users 21, it is to be understood that system 11 is preferably scaled to support any number of concurrent users 21 (as well as any number of venues 17) without departing from the spirit of the present invention.

Additionally, in the present embodiment, compute device 29-1 is represented as a mobile device, whereas compute device 29-2 is represented as a personal computer. However, it is to be understood that access to activity tracker 13 by end user 21 can be achieved using any compute device that is able to electronically communicate with central controller 23 tracker through a corresponding software application (e.g. a web browser or mobile application).

Lastly, each end user 21 is represented in FIG. 1 as being remotely located relative to geographic region 19. However, it is to be understood that a user 21 located within geographic region 19, or even within a particular venue 17, could similarly access activity status data from activity tracker 13 (e.g., to decide whether to move to a different venue 17) without departing from the spirit of the present invention.

### Illustrative Use of System 11 to Track Venue Activity

As referenced above, an end user 21 can readily evaluate the real-time activity status of a number of venues 17 within a geographic region 19 by connecting with activity tracker 13 (e.g., using a designated mobile application). In this capacity, potential patrons can compare the real-time, crowd-based popularity of various establishments when formulating dining and/or entertainment plans, which is highly desirable.

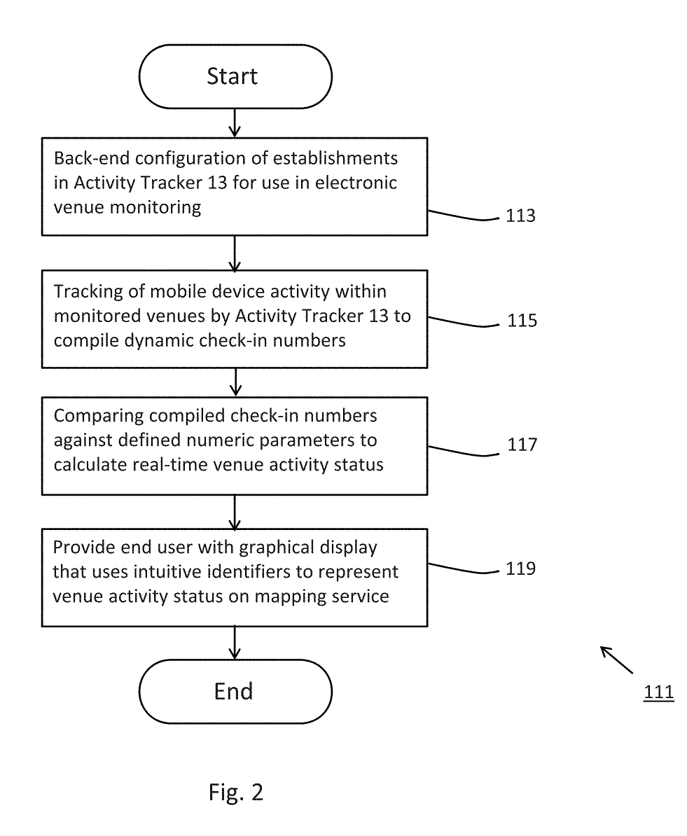

Referring now to FIG. 2, there is shown a flow chart depicting an illustrative method for tracking the activity status of a series of venues 17 within a user-modifiable geographic region 19 using system 11, the method being identified generally by reference numeral 111.

As the first step of method 111, certain details relating to each venue 17 are input as part of a back-end configuration step 113. Specifically, core information relating to each venue 17 is captured by central controller 23 that includes, but is not limited to, the establishment name, business type, unique back-end identifier, and the like.

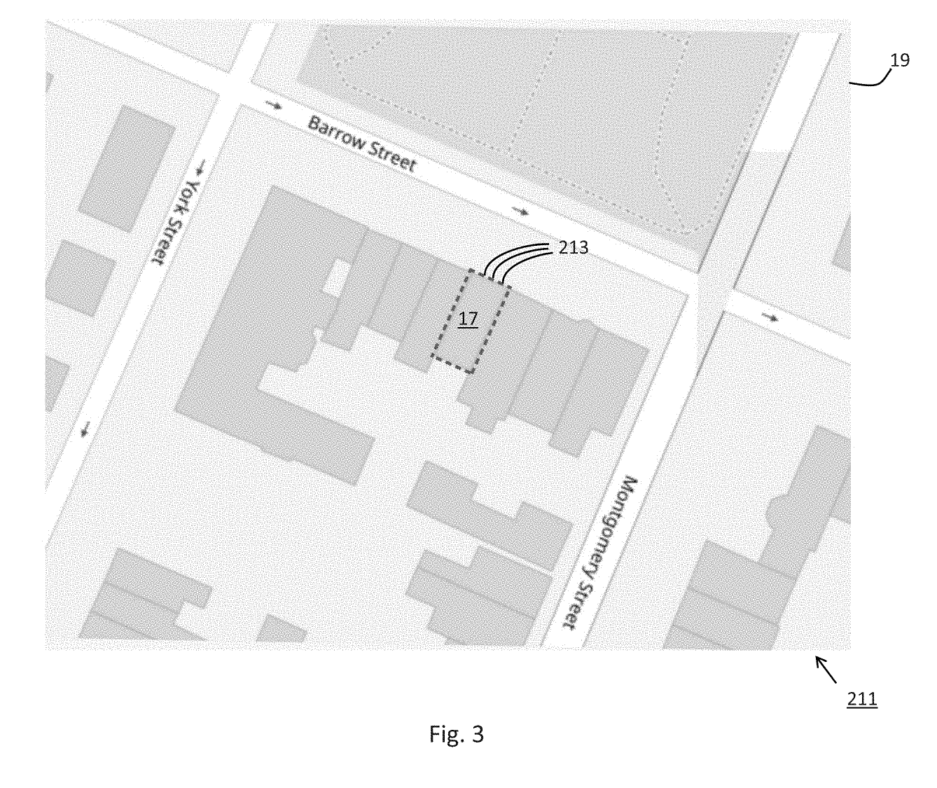

As an additional component of set-up step 113, the geographic location for each venue 17 is defined. Referring now to FIG. 3, there is shown a sample back-end screen display that is useful in understanding how the geographic location of each venue 17 is defined, the screen display being identified generally by reference numeral 211.

In screen display 211, the location of a venue 17 is represented in relation to a broader geographic region 19 using a web mapping service. As can be seen, a series of nodes 213 that define the immediate physical periphery of venue 17 is integrated into the web mapping service as part of configuration step 113.

As can be appreciated, the geographic coordinates (i.e. latitude and longitude) for each node 213 are preferably captured by central controller 23 in order to mark the physical periphery of venue 17. As a consequence, the geographic data associated with each node 213 forms a virtual boundary that can be used to determine when a mobile device 15 is located at/within venue 17.

Referring back to FIG. 2, upon completion of configuration step 113, activity tracker 13 continuously tracks the presence of active mobile devices 15 within monitored venues 17 as part of a back-end tracking step 115. Specifically, central controller 23 directly and/or indirectly fetches geolocation data from active mobile devices 15.

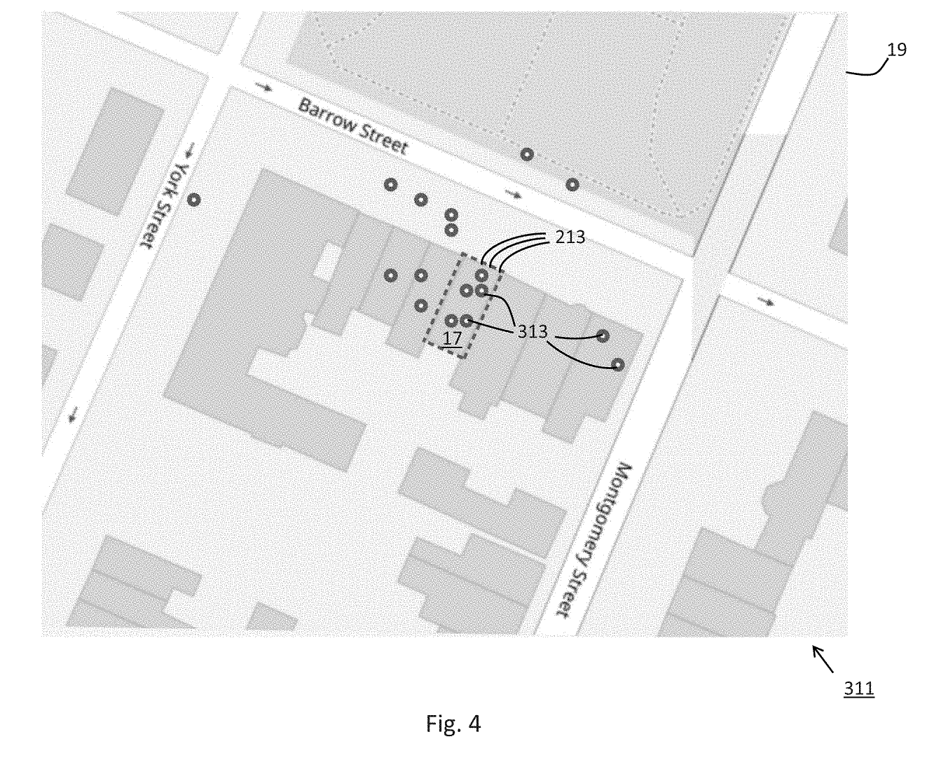

By comparing the geolocation data from each detected mobile device 15 against the virtual boundary for each venue 17 established in step 113, central controller 23 can estimate active crowd sizes within monitored venues 17. For instance, referring now to FIG. 4, there is shown a sample back-end screen display that is useful in understanding how geolocation data from mobile devices 15 can be used to estimate crowd sizes in monitored venues 17, the sample screen display being identified generally by reference numeral 311.

In screen display 311, venue 17 is, once again, represented in relation to a broader geographic region 19 using a web mapping service. Additionally, nodes 213 designating the physical periphery of venue 17 remain incorporated in the mapping program.

However, screen display 311 is further provided with a plurality of markings 313 that represent the estimated location of each active mobile device 15 from which geolocation data has been fetched. Central controller 23 for activity tracker 13 continuously tracks the location of each mobile device 15 in relation to the virtual boundary established for each monitored venue 17. For instance, in the present example, five active mobile devices 15 appear located within monitored venue 17.

If a mobile device 15 remains inside the virtual boundary for a defined period (e.g. 10 minutes), activity tracker 13 considers that device 15 checked-in to venue 17. Preferably, confirmation of checked-in status can be accomplished through an electronic check-in feature provided in the designated mobile application. The use of a predefined duration before applying a checked-in status prevents the misidentification of non-patrons as active crowd members (e.g. individuals using a restroom).

Referring back FIG. 2, activity tracker 13 uses check-in data to calculate an activity status for each monitored venue 17 as part of a back-end processing step 117. Specifically, central controller 23 regularly surveys monitored venues 17 and, in turn, maintains a total user check-in count for each venue 17. As such, central controller 23 is able to continuously track the crowd size at each venue 17 in real time.

Activity tracker 13 then compares the total user check-in count for each venue 17 against a defined numerical parameter to determine activity status. The particular numerical parameter to be used for each venue 17 is preferably stored in an appropriate table that is readily accessible by central controller 23.

In the present embodiment, the defined occupancy load for each venue 17 is used as the numerical parameter against which the total user check-in count is compared. In this capacity, the check-in count can be used by central controller 23 to calculate the real-time occupancy rate for each venue.

As can be appreciated, the defined occupancy load for each venue 17 is used as the numerical parameter against which the total user check-in count is compared because (i) occupancy load information is typically required by permits and is therefore often publicly available for inspection and (ii) occupancy rates provide an accurate reflection of the relative crowd size and overall popularity of venues. For occupancy loads not publically available, the area defined by the virtual perimeter established in configuration step 113 can be used to estimate a maximum occupancy value.

However, it should be noted that the use of occupancy loads as the numerical parameter against which check-in counts are compared is merely illustrative. Rather, it is to be understood that other types of numerical parameters could be utilized in place thereof without departing from the spirit of the present invention. Examples of alternate numerical parameters that could be used in place of occupancy loads include, but are not limited to, a fixed numerical factor based on the establishment size or genre, a 30-day average check-in size, etc.

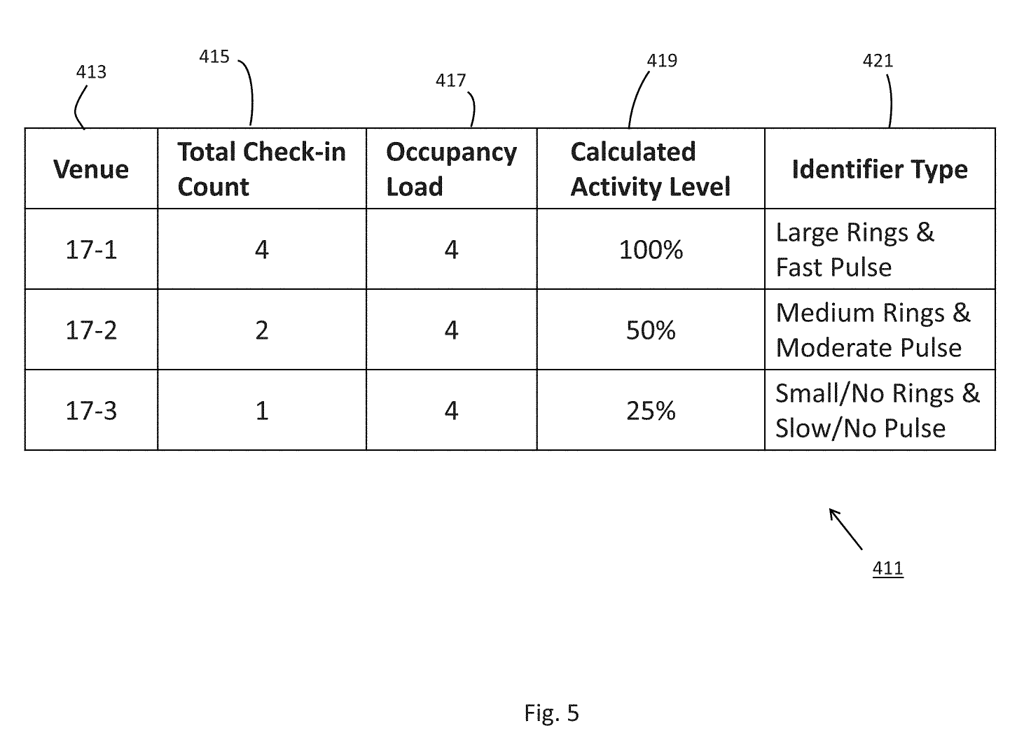

Referring now to FIG. 5, there is shown an illustrative chart that is useful in understanding back-end processing step 117, the chart being represented generally by reference numeral 411. As can be seen, chart 411 displays the disparity in crowd sizes amongst venues 17-1, 17-2, and 17-n depicted in FIG. 1.

Specifically, chart 411 includes (i) a venue column 413 which lists all of the active venues 17 being monitored, (ii) a total check-in count column 415 which lists the number of active mobile devices 15 tracked within each venue 17, (iii) an occupancy load column 417 which lists the defined occupancy load for each venue 17, (iv) an activity level, or occupancy rate, column 419 which is calculated by dividing the total check-in count for each venue by its defined occupancy load, and (v) a user display graphical identifier column 421 that compares the activity status level in column 419 against ranges defined in a lookup table and therefore defines how each calculated activity level is graphically displayed to the end user, which will be explained further in detail below.

Referring back to FIG. 2, the continuously compiled activity status of venues 17 is presented to end user 21 through a front-end graphical display with display icons, or identifiers, which intuitively reflect the crowd status of each venue 17, the front-end presentation step being identified generally by reference numeral 119. As referenced previously, the interface provided to end user 21 is preferably rendered using a designated software application (e.g. a mobile application installed on device 21).

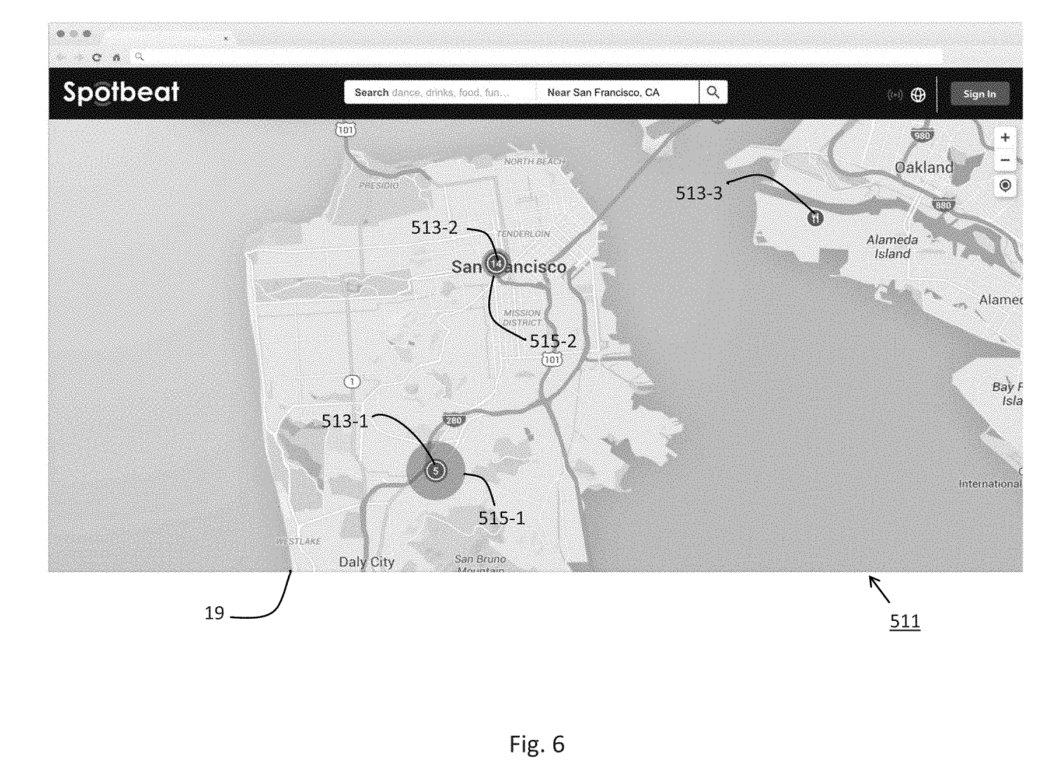

Referring now to FIG. 6, there is shown a sample front-end screen display that is useful in understanding how an end user 21 receives the activity status data compiled by central controller 23, the screen display being identified generally by reference numeral 511. As can be seen, screen display 511 represents a geographic region 19 using an electronic mapping service.

It should be noted that the geographic region 19 provided in screen display 511 is user-modifiable. In this sense, end user 21 can adjust (i.e. expand or contract) the size of region 19 to reflect the specific area where activity status data is desired.

Furthermore, it should be noted that data filtering is not limited to geographic region modification. Rather, although not shown herein, it is to be understood that the operating software application may include additional tools to filter venues based on user-specified preferences (e.g., based on venue categorizes, price designations, etc.).

In screen display 511, monitored venues 17 are represented on the mapped display using easily discernable markers 513-1 thru 513-3, each marker 513 preferably being represented with a useful icon (e.g., a unique numerical ID that is linked to venue information and/or an icon indicative of the services rendered, such as fork/knife icon which denotes a restaurant).

As a feature of the present invention, dynamic visual identifiers, or signs, 515-1 and 515-2 are applied to selected markers 513 to demonstrate current activity status. More specifically, the particular appearance of each animated identifier 515 intuitively reflects the calculated activity status of its corresponding venue 17. As a consequence, end user 21 can readily compare the real-time popularity of multiple venues 17 within a common geographic region 19.

In the present embodiment, dynamic identifiers 515 reflect activity status based on graphic size, color and pulse rate. For instance, in FIG. 6, a highly active venue 17 (e.g., as represented by marker 513-1) has a dynamic identifier 515-1 in the form of a pair of relatively large, darkened rings which are arranged concentrically around its associated marker 513-1 and that pulse, or strobe, at a fast rate to intuitively denote high popularity. More moderately active venues (e.g., as represented by marker 513-2) has a dynamic identifier 515-2 in the form of a pair of medium-sized, light-colored rings which are arranged concentrically around its associated marker 513-2 and that pulse, or strobe, at a more moderate rate (or even remain static) to intuitively denote moderate popularity. Minimally active, or non-active, venues (e.g., as represented by marker 513-3) are provided with no dynamic identifier 515 to intuitively denote its low popularity, or closed, status.

It should be noted that front-end display 511 provided to end user 21 is not limited to any particular type or style of dynamic identifiers 515. Rather, in lieu of differently sized rings that pulsate at varying rates, display 511 may utilize alternative means of indicia to intuitively denote venue popularity (e.g., using a shape-based or star-coded system) without departing from the spirit of the present invention.

Additionally, in screen display, the variance in activity status between venues 17 is represented using three distinct levels. However, it should be noted that the present invention is not limited to any particular number, or grades, of activity status levels. Rather, it is to be understood that a greater or fewer number of activity status levels could be implemented in the design without departing from the spirit of the present invention.

Although not shown herein, it is to be understood that basic user information (e.g., age or sex) could be extracted with the geolocation data in order to construct a crowd profile at each monitored venue 17. In this manner, a user can evaluate not only the relative crowd size but also the crowd type when making a venue determination.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

1. A system for monitoring a plurality of venues, the system comprising:
(a) an activity tracker, the activity tracker comprising a central controller that maintains a count of active mobile devices located within each of the plurality of venues, the central controller comparing the count of active mobile devices within each of the plurality of venues against a corresponding maximum occupant load to calculate an activity status for each monitored venue; and
(b) an end user compute device in electrical communication with the central controller;
(c) wherein the end user compute device is adapted to retrieve information from the central controller that is reflective of the count of active mobile devices located within a selection of the plurality of venues, the activity status for the selection of the plurality of venues being represented on the end user compute device via at least one graphical display.

2. The venue monitoring system as claimed in claim 1 wherein the central controller maintains the count of active mobile devices located within each of the plurality of venues in real time.

3. The venue monitoring system as claimed in claim 1 wherein the central controller fetches geolocation data from a plurality of active mobile devices to determine the count of active mobile devices located within each of the plurality of venues.

4. The venue monitoring system as claimed in claim 3 wherein the geolocation data is fetched directly from at least one of the plurality of active mobile devices.

5. The venue monitoring system as claimed in claim 3 wherein the geolocation data is fetched indirectly from a third party geolocation provider.

6. The venue monitoring system as claimed in claim 3 wherein the central controller defines a geographic perimeter for each venue to be monitored.

7. The venue monitoring system as claimed in claim 6 wherein the central controller defines the geographic perimeter for each venue to be monitored using a series of nodes, each node having known geographic coordinates.

8. The venue monitoring system as claimed in claim 7 wherein the fetched geolocation data is compared against the geographic perimeter for each venue to be monitored to determine the count of active mobile devices located within each of the plurality of venues.

9. (canceled)

10. (canceled)

11. (canceled)

12. The venue monitoring system as claimed in claim 1 wherein the selection of the plurality of venues is modifiable by the end user.

13. The venue monitoring system as claimed in claim 11 wherein the at least one graphical display includes a mapping service.

14. The venue monitoring system as claimed in claim 13 wherein at least one dynamic identifier is incorporated into the mapping service, each identifier reflecting the count of active mobile devices located within the selection of the plurality of venues provided to the end user.

15. The venue monitoring system as claimed in claim 14 wherein each identifier reflects the count of active mobile devices located within the selection of the plurality of venues through variance in size.

16. The venue monitoring system as claimed in claim 14 wherein each identifier reflects the count of active mobile devices located within the selection of the plurality of venues through variance in pulsation rate.

17. The venue monitoring system as claimed in claim 14 wherein each identifier reflects the count of active mobile devices located within the selection of the plurality of venues through variance in color.
